(19) United States
(12) Patent Application Publication
(10) Pub. No.: US 2002/0129908 A1
(43) Pub. Date: Sep. 19, 2002

(54) Shade cover for a handle

(76) Inventor: Shigeo Nakagawa, Hyogo (JP)

Correspondence Address: Shigeo Nakagawa, Park Court Takashou, No. 303, 9-1 Takashou-cho, Akashi, Hyogo, JP

(21) Appl. No.: 10/097,824

(22) Filed: Mar. 12, 2002

(30) Foreign Application Priority Data
Mar. 14, 2001 (JP) 2001-121762

(51) Int. Cl. B60J 1/20

(52) U.S. Cl. 160/370.23

(57) ABSTRACT

This Handle Shade Cover is represented by dimensions suitable for covering a vehicle handle, which is composed at least one foldable bellows assembly and cover assemblies installed in both the ends of the bellows assembly. The bellows assembly is featured by elastic and expansible bellows comprising practically U-with angled edges shaped or L-shaped cross sections. On both ends of bellows, the cover assembly is installed and provided with an engagement retainer respectively.

### BACKGROUND OF THE INVENTION

This invention relates to the Handle Shade Cover primarily to be attached to a car handle so as to prevent the handle and the relating parts from overheating by means of shading the direct sunshine.

Vehicle handles are based up under the direct sunshine, in particular, under the burning sun in the summer season. As a result, it becomes difficult to keep the handle with bare hands. In the past, in order to prevent the handle from overheating, a foldable screen was arranged alongside the indise front glass, or otherwise a bag-like cover was applied over the handle section as a so-called sun shade.

### SUMMARY OF THE INVENTION

According to the prior art, the installation and removal work of a shade screen to be arranged on the inside front glass was troublesome, as well as there was a problem to be solved that such a folded shade screen requires a spacious space for storage.

In addition, this type of shade screen according to the prior art cannot prevent the inside room of a vehicle from entering the sun shine through both side glasses.

More particularly to describe, the conventional type shade screen was unable to satisfy the requirements of a shade screen commodity so as to prevent the handle section from overheating.

For other type of a conventional shade screen, such as a bag-like handle shade cover manufactured according to the prior art, it was bulky and lack of easiness as well.

This invention relates to the Handle Shade Cover featured by easy installation and less spacious storage area, as well as featured by high thermal-insulation properties.

The above and other objects and features of the invented Handle Shade Cover have resolved the above problems. The Handle Shade Cover is represented by dimensions suitable for covering a vehicle handle, which is composed at least one foldable bellows assembly and cover assemblies installed in both the ends of the bellow assembly.

The bellows assembly is featured by elastic and expansible bellows comprising practically U with angled edges-shaped or L-shaped cross-sections. On both the ends of bellows, the cover assembly is installed and provided with an engagement retainer respectively.

### BRIEF DESCRIPTION OF THE DRAWINGS

FIG. 1 Perspective view showing the embodiment of the said invented Handle Shade Cover

FIG. 2 Perspective view showing the embodiment of the said invented Handle Shade Cover

FIG. 3 Perspective view showing the embodiment of the said invented Handle Shade Cover

FIG. 4 Perspective view showing bellows to make up the said invented Handle Shade Cover

FIG. 5 Cross-sectional view showing the embodiment of the said invented Handle Shade Cover with the installed handle

FIG. 6 Perspective view showing the embodiment of the said invented Handle Shade Cover

FIG. 7 Cross-sectional view showing the embodiment of the said invented Handle Shade Cover

FIG. 8 Cross-sectional view showing the embodiment of the said invented Handle Shade Cover

FIG. 9 Perspective view showing bellows to make up the said invented Handle Shade Cover

FIG. 10 Cross-sectional view showing the embodiment of the said invented Handle Shade Cover with the installed handle

FIG. 11 Cross-sectional view the embodiment of the said invented Handle Shade Cover with the installed handle

### DETAILED DESCRIPTION OF THE INVENTION

The preferred arrangement of this invention is explained based on the applicable figures illustrated on drawings one by one.

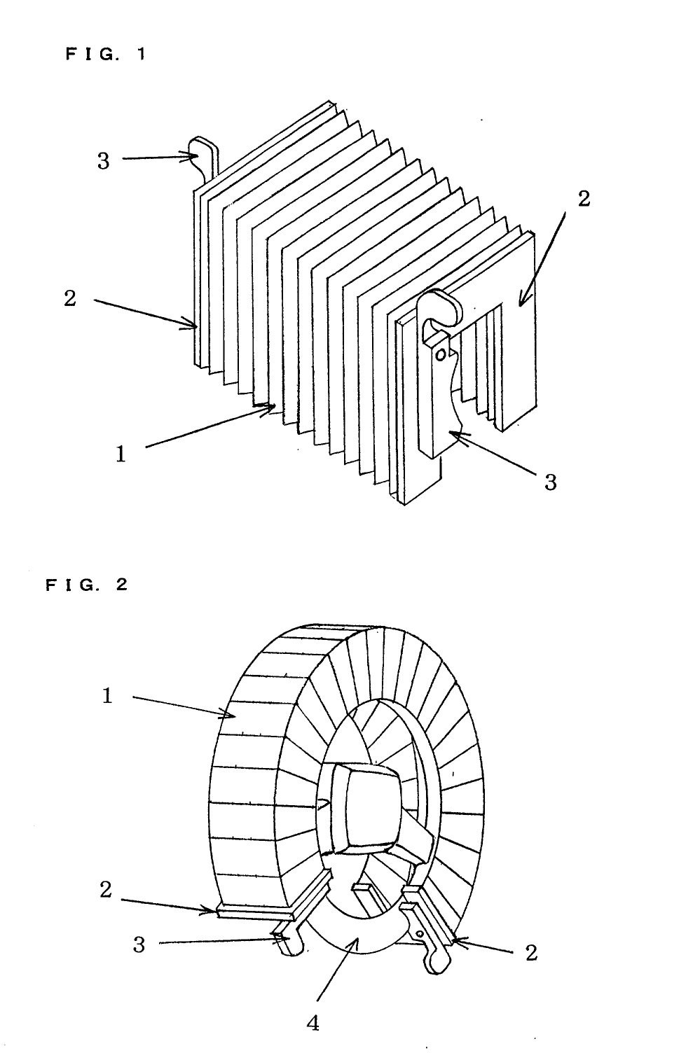

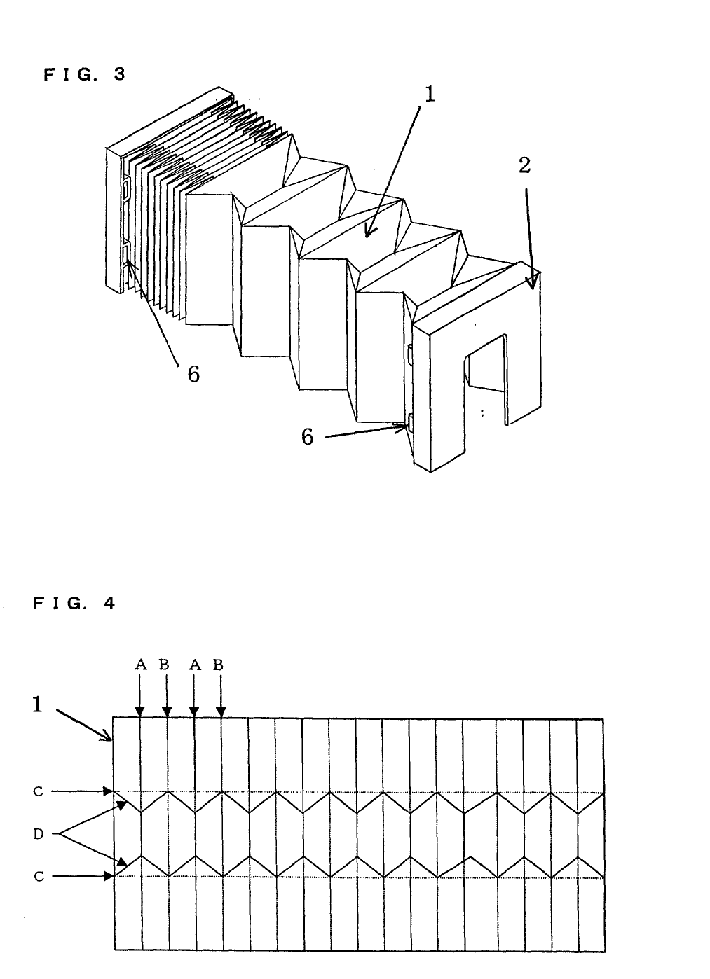

Referring first to the example of the Handle Shade Cover shown on FIG. 1, a bondable clip-shaped Retainer 3 is installed to the Cover 2 provided on both the end of the Bellows 1.

FIG. 2 illustrates an example that the Handle Shade Cover is wound around the outer peripheral portion of the Handle 4 as shown in FIG. 1, and fixed with the Retainer 3.

According to the embodiment of this invention, the bellows assembly is a multiply folded belly-like shade assembly molded solidly and connectable ar right angles. But, the above is only one example of the shape of the bellows in general.

The Cover 2 installed on the bellows end is useful to make bellows' expansion and contraction movement flexibly, as well as can transmit uniform flexibility forces to the bellows, so as to protect the bellows from unbalanced deformation caused by the application of external local stresses.

The bellows assembly of the invented Handle Shade Cover shows an example of the U with angled edges-shaped cross-sectional molded bellows obtainable from folding plain sheet materials. FIG. 4 illustrates an example that the bellows assembly is being expanded.

The structures of the invented Handle Shade Cover are provided with miscellaneous crosswise folded lines A & B spaced alternately and equally, as well as arranged at right angles in the logitudinal and bellows' expandable direction and further provided with bent two-row vertical folded lines C arranged at obtuse angles practically in the right angle direction in proportion to the said crosswise folded lines. Furthermore, inflection points are provided on the crosswise folded lines, and zig-zag-shaped oblique folded lines D are comprised practically in the right angle direction, through which the crosswise folded lines and vertical folded lines. Furthermore, inflection points are provided on the crosswise folded lines, and zig-zag-shaped oblique folded lines D are comprised practically in the right angle direction, through which the crosswise folded lines and vertical folded lines compose the said inflection points.

The foregoing description and illustration of the said Handle Shade Cover are featured by bending the said belt sheet materials in the folded portion and by composing bellows assembly.

Referring to the foregoing applicable drawing, dotted section is bent at the crest portion and continuous line section is bent at the root portion.

In this way, the folded sheet-like shading materials can be composed so that both sides of the bellows may be falling down inward so as to envelope and cover the handle, resulting in the improvements of shading capability.

Referring more particularly to the drawing, Cover 2 provided on both the end of the bellows has a concave section in which the folded bellows materials are storable.

More particularly to describe the above, the folded bellows is stored in the concave section, in addition, the Engagement 6 is assembled with the cover assembly so that both the covers can be held under the closely attached condition.

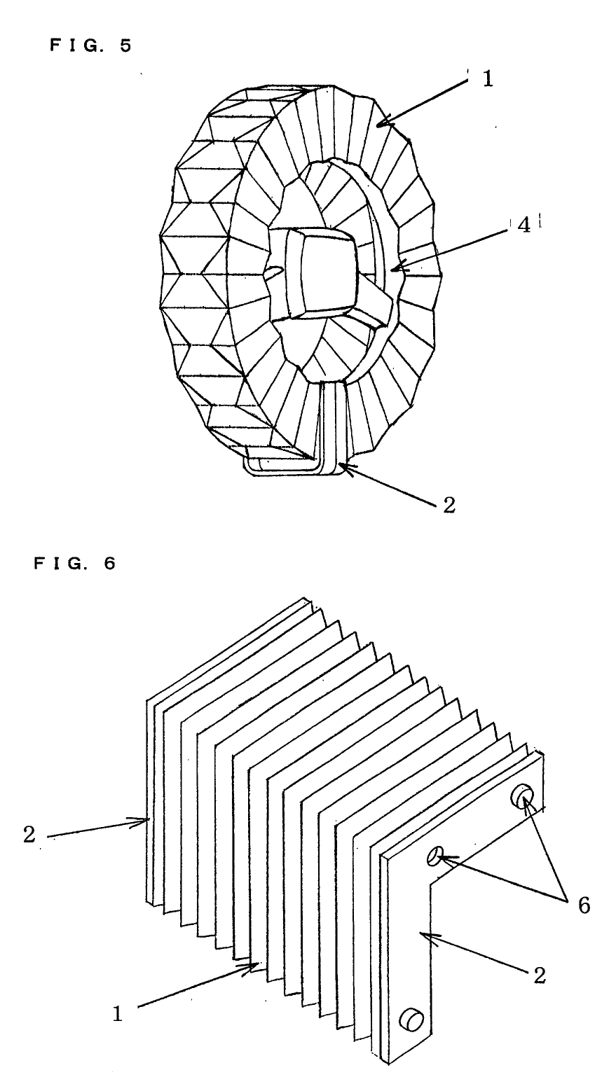

Furthermore, as an engagement section, also face Fastener 5 is installed to the outside of the cover, through which when the said Handle Shade Cover is required to install, referring to FIG. 5, the outside faces of the cover assembly are engaged each other under the condition that the bellows assembly can go round the handle.

Referring to FIG. 6, as the object of the present invention, the cross-sectional bellows part is illustrated as the L-shaped cross-section.

The cover assembly represented by both ends of the bellows is also composed of an L-shaped cross-section.

In addition, the cover assembly is also composed with the freely mountable and dismountable Engagement 6.

In the-same way as the example illustrated in FIG. 5, the Engagement 6 can be retained under the condition that the bellows assembly can go round the handle.

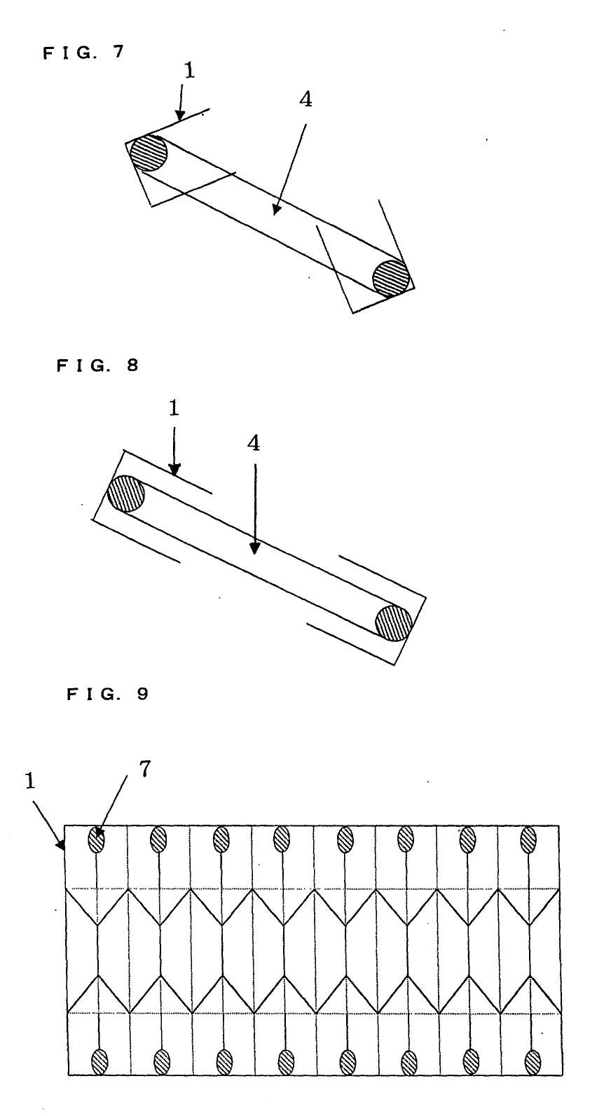

Referring to FIG. 7, when the said Handle Shade Cover is required to install, an example that the bellows receives reversed forces is illustrated.

Referring more particularly to the drawing, in case the bellows assembly is expanded freely, the bellows assembly might receive a stress such as the entire part of the bellows is reversed through the self contracting force of the bellows itself.

In this way, the shading materials fixed with handle are not only a poor appearance, but also, it is afraid that the sunshine might directly hit the handle passing through the U with angled edges-shaped cross-sectional opening.

FIG. 8 illustrates the cross-sectional view of the preferred relationship between the handle and the bellows. As described in the latter section, if both the end parts of the bellows are so arranged not to elongate more than a certain length, the bellows can be installed orderly as illustrated.

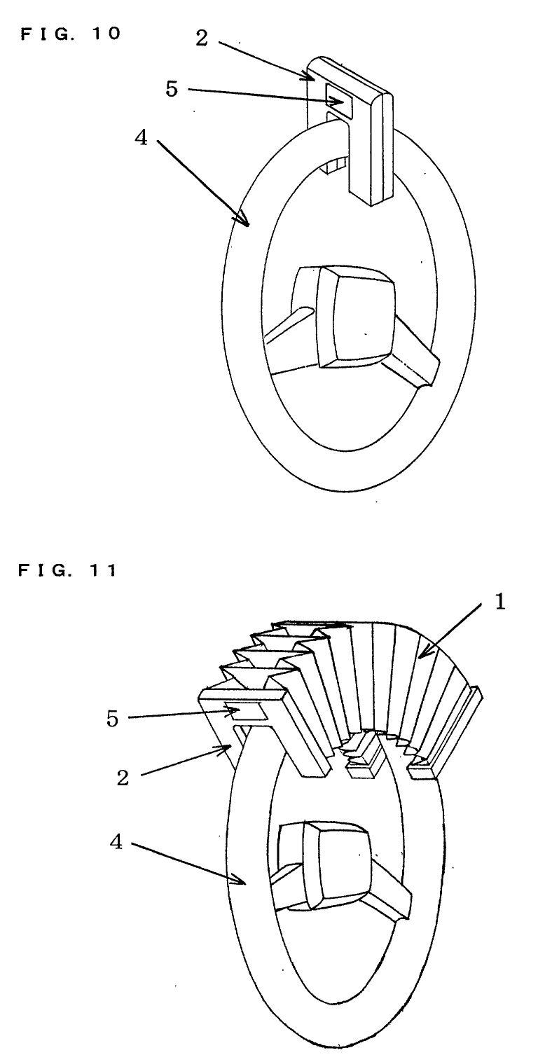

FIG. 9 illustrates an expansion plan, in which an example of bonded places is provided alongside the longer side of the shading material of bellows. Referring more particularly to the drawing, the Bonded section 7 is shown by oblique lines. The primary object of bonding in the present invention is to suppress the expanding amount of the bellows in the bonded place, and as illustrated in FIG. 7, the another object of the bonding is to prevent the bellows from reversing.

The bonding place may be allowed to be the backside of the slashed section illustrated on this figure, or allowed in the slashed section bonded provided with an adequate spacing.

Through the bonding of the said place, even if the bellows assembly was expanded, the bellows assembly is extended externally like an arch.

Than as illustrated in FIG. 8, the bellows can closely fit with the handle. As a result, bellows wound around the handle can effectively prevent the bellows from reversing and loosening.

Referring more particularly to the figure, when the bellows assembly was expanded freely and reasonably, the expanded length is practically equal to the inside peripheral length of the bellows assembly when the handle was rotated fully one turn in the bonded place. In the same way, in the non-bonded place, when non-bonded portion was reasonably expanded, it is preferable that when the handle was rotated fully one turn around the handle, the expandable length of the bellows assembly is practically the same as the outside peripheral length of the bellows assembly.

The preferred arrangement and actual application of the present invention for the said Handle Shade Cover are described and illustrated as follows:

FIG. 10 illustrates a state that the folded handle shade unit was fitted with the upper part of the Handle 4.

While maintaining this state, when the right and left Covers 2 are being opened towards both sides, the Bellows 1 can be expanded so as to wrap up the handle as shown in FIG. 11.

Alongside the handle, when the right and left cover assemblies are expanded further, and then, when the outside parts of the cover were connected each other, as illustrated in FIG. 5, the entire part of the handle can be covered fully with the Bellows 1.

FIG. 10 illustrates sectional views of the Bellows 1 and Handle 4 installed on the handle. Referring to these figures, the preferred arrangement of the said invented Handle Shade Cover bellows assembly and the contracted section with the handle are restricted, and as a result, the portions contracted with the curve-formed handle become practically a point contract.

Referring more particularly to the figure, because the contracted portion is very small, the thermal transmission from the bellows assembly to the handle van be restricted at minimum. Furthermore, a space provided between the handle and bellows assembly is useful to play a role of an air heat insulation layer.

The preferred arrangement of the present invented raw materials of bellows assembly is rich-shading-capability represent by such as paper, cloth and metallic films. For example, if aluminium metallic vapor layer composed material is used as a preferable shading material, harmful radiation

1. This invention relates to a Sahde Cover for a handle. The preferred arrangement of this invention is to provide a rigidly assembled Cover unit 2 on both ends of elastic and expansible Bellows assembly 1 composed of practically U with angled edges-shaped or L-shaped vertical cross-section in the telescopic direction manufactured by highly shade-able property materials.
Another object of the invention is to provide a shade cover assembly with an engagement through which outside cover faces and inside cover faces can be connected and disconnected freely, or with an engagement through which the shade cover assembly is attachable and detachable to and from the said handle.

2. This invention related to the said device described in the proceeding claim 1 above. The embodiments of claim 2 is featured by belt sheet materials provided with miscellaneous cross folded lines A & B arranged at right angles in the longitudinal direction and further provided with bent two-row vertical folded lines A arranged at obtuse angles practically in the right angle direction in proportion to the said crosswise folded lines.
Furthermore, inflection points are provided on the crosswise folded lines, and two-row zigzag-shaped oblique folded lines D are comprised prectically in the right angle direction, through which the crosswise folded lines and vertical folded lines compose alternately the said inflection points. The foregoing description of the said belt sheet materials in the bent portion and by composing bellows assembly.

3. This invention relates to the said device described in the proceeding claim 2 above. The embodiments of claim 3 is featured by a bellows assembly, on which places adjacent to both ends of crosswise bent lines A & B composed of the bellows assembly are partially bonded or welded.
The advantage of the invention is featured by forming a partial connection of closely provided bellows or by forming a one-piece structure of the bellows assembly when the bellows assembly is required to fold.
